(19) United States
(12) Patent Application Publication
(10) Pub. No.: US 2016/0019501 A1
(43) Pub. Date: Jan. 21, 2016

(54) Systems, methods and computer-program products for automation of dispatch of shipment delivery order

(71) Applicants: Dmitri Olechko, Port Moody (CA); Alex Mateesco, Port Moody (CA)

(72) Inventors: Dmitri Olechko, Port Moody (CA); Alex Mateesco, Port Moody (CA)

(21) Appl. No.: 14/800,699

(22) Filed: Jul. 16, 2015

Related U.S. Application Data
(60) Provisional application No. 62/025,907, filed on Jul. 17, 2014.

(51) Int. Cl. G06Q 10/08

(52) U.S. Cl. CPC G06Q 10/08355

(57) ABSTRACT

Various embodiments of the present invention provide system, methods and computer-program products for dispatching of shipment delivery order with a pre-determined service window to a single delivery agent of a common carrier. In general, various embodiments of the invention involve minimizing the cost of delivery while satisfying service conditions by determining and comparing the costs of shipment delivery if it were performed by any of the delivery agents in the existing common carrier's fleet, taking into account various factors, such as current and future load and route of each delivery agent, type of vehicle of delivery agent, geographical location of delivery agent at the time of dispatch decision, predicted route of the delivery agent, predicted loading and unloading times for package shipment, and data obtained by statistical analysis of prior service data. Other embodiments of the invention involve calculating the optimal time for making an automated dispatch decision by the computer-program product. Yet other embodiments of the invention involve determination of optimal time for delivery agent to start delivery of a package shipment.

### BACKGROUND

1. Field of the Invention

Embodiments of the present invention are related to systems coordinating the real-time dispatching of shipment delivery orders with known service window in the defined geographical area among the fleet of delivery agents, who may be using various means of transportation for such deliveries.

2. Brief Description of Related Images

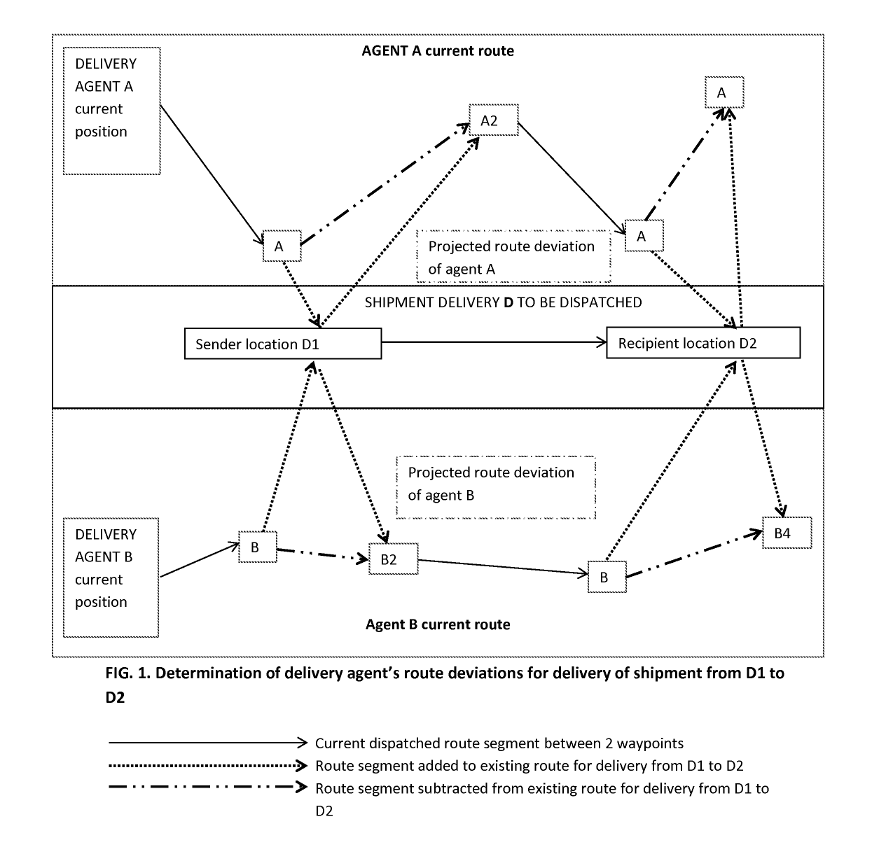

FIG. 1. Determination of delivery agents' route deviations for delivery D of a shipment from sender location D1 to recipient location D2

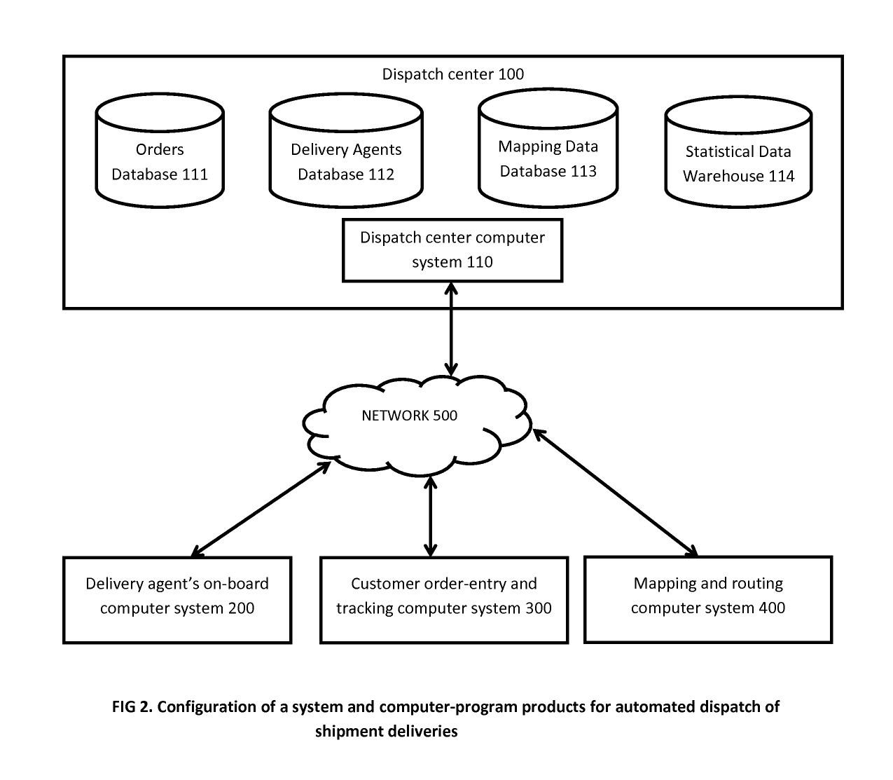

FIG. 2. Components of a system and computer-program products for automated real-time dispatch of shipment deliveries

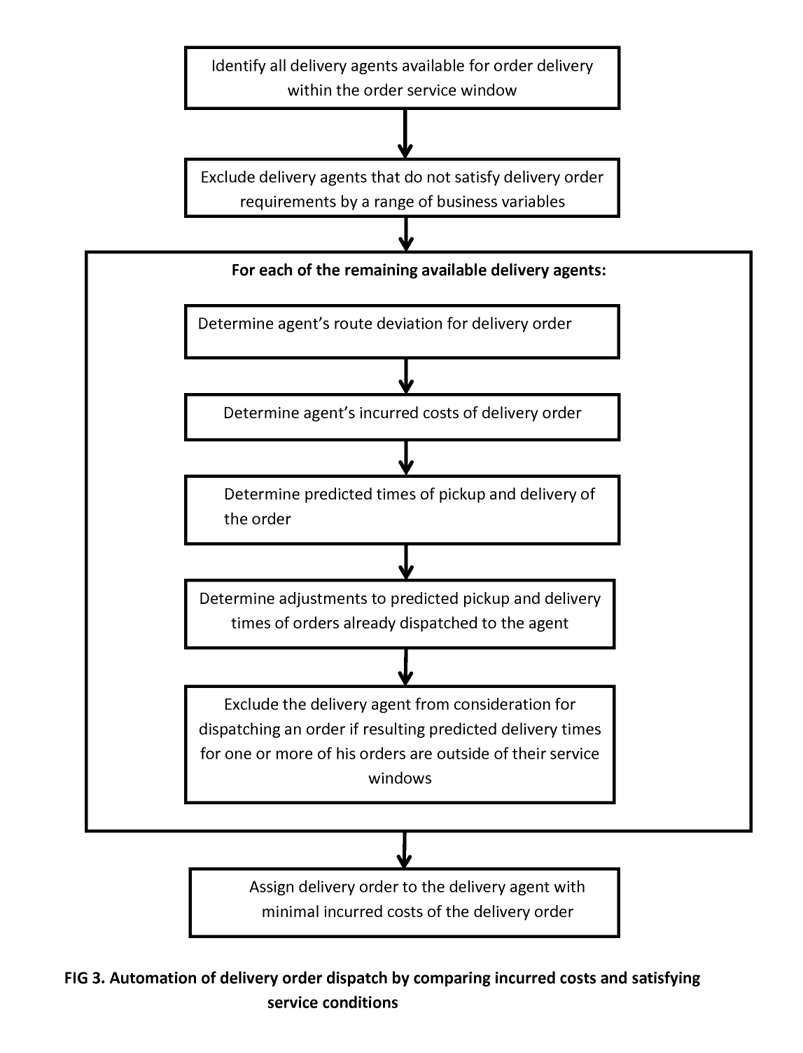

FIG. 3. Automation of delivery order dispatch by comparing incurred costs and satisfying service conditions

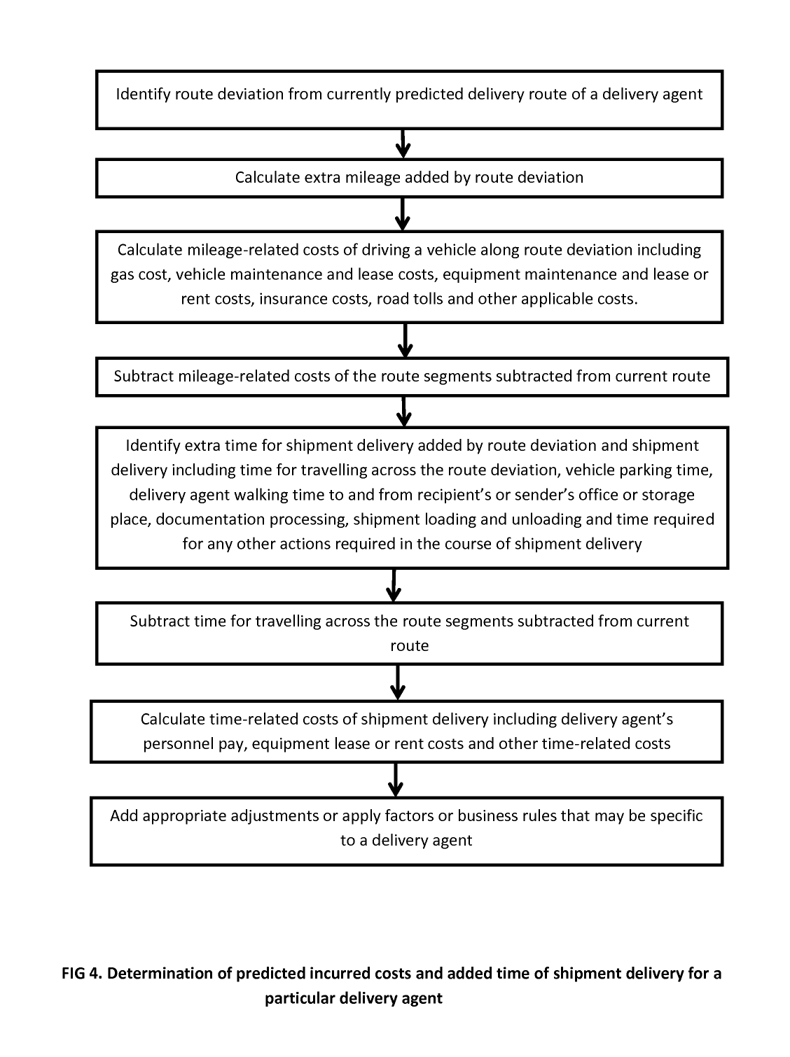

FIG. 4. Determination of predicted incurred costs and added time of shipment delivery for a particular delivery agent

### DETAILED DESCRIPTION OF EMBODIMENTS

### Overview of Exemplary Shipping Network

Businesses and individuals are often using various types of transportation and delivery companies to ship various goods. Many of those shipments are handled by one delivery agent, who picks up the shipment from the sender and delivers it to the recipient. A lot of those transportation companies are operating exclusively within a limited geographical area, such as a metropolitan area, city, state, or other service area determined by the transportation company. For example, bike couriers may operate within downtown core of the city. These transportation companies are frequently offering service with guaranteed delivery within a set period of time after the order is made, such as 1 hour, 2 hours, 4 hours, etc. Other service offerings may include the guarantee to deliver before a certain time on the day of the order, for example, before 5:00 PM, or before a certain time on the next day, or the next business day, and so forth. In all those service models shipment delivery must be completed within a certain service window.

The transportation business of these companies, commonly known as couriers, or same-day messengers is essential to economic life. A lot of logistical processes in manufacturing, services, government and most other areas of life rely on the transportation, or courier companies for their daily operations.

An essential attribute of the delivery services of this type is that a large part of the delivery orders are not made ahead of time. Rather, an order is placed at or immediately prior to the time when the shipment is ready to be sent. This provides the customers with the flexibility that suits their needs.

At the same time it presents the delivery service providers with the challenge of dispatching the orders in the most cost-effective manner. Upon the conditions described, preliminary planning of deliveries, fleet distribution, vehicle loads and routing is impossible. Therefore, the task of real-time dispatch optimization is essential for the delivery service providers, such as couriers and same-day local messengers.

### Automation of the Delivery Order Dispatching Decision by Determining Route Deviation Incurred Costs

One exemplary embodiment of a delivery company operation is illustrated in FIG. 1. In the illustrated embodiment a shipment D originates at the point D1 with its destination being point D2. There are 2 delivery agents A and B. Both delivery agents have some deliveries already dispatched to them. Their routes to deliver already dispatched orders are depicted as A1-A2-A3-A4 and B1-B2-B3-B4, respectively.

In one embodiment, a route deviation is calculated for agents A and B with respect to shipment D. A route deviation is calculated for agent A as the sum of route segments A1-D1 and D1-A2 to include shipment D receiving address in agent's A route plus the sum of route segments A3-D2 and D2-A4 to include shipment D destination address in agent's A route. Existing route segments A1-A2 and A3-A4 are subtracted from the deviated route determination. Route waypoints A1 and A2 are selected for route deviation calculations as the closest waypoints to receiving address D1 on the delivery agent A's route. Route waypoints A3 and A4 are selected for route deviation calculations as the closest waypoints to destination address D2 on the delivery agent A's route. Those waypoints may be pickup or delivery addresses of the other shipments currently dispatched to agent A, as well as any other points on the previously determined delivery route of agent A.

In a similar fashion, route deviation for delivery of shipment D is determined for agent B.

In one embodiment, a decision of dispatching shipment D to one of the delivery agents A and B is made by comparing their respective route deviations for delivery of shipment D. An extra distance of travel along the route, as well as the other business and other factors, such as road conditions, delivery agent vehicle type, etc may be used to calculate the cost of delivery if it were performed by delivery agent A or delivery agent B. Those factors are described in more details in other embodiments.

Concurrently, a determination of predicted travel times along the route is made for both delivery agents. A determination is made whether each of the delivery agents can satisfy the delivery order service conditions, based on predicted shipment D delivery time, and other business factors. For example, a delivery order may include special service conditions, such as vehicle type, or loading equipment, etc. A determination is also made to ensure that delivering shipment D does not change agent's other predicted delivery times so that they no longer comply with their respective service windows. Those factors are evaluated before making a dispatching decision. In some instances, the delivery agents that do not satisfy service conditions are excluded from the pool of potential delivery agents for a given shipment.

The dispatching decision is made to dispatch the delivery of shipment D to that delivery agent, who will complete the shipment delivery with minimal costs incurred and complying with other requirements of the delivery including the predicted delivery time being within the delivery service window.

### Determination of Predicted Incurred Costs of Order Delivery

In some embodiments, determination of the incurred costs of order delivery for each delivery agent is made. This determination comprises an evaluation of a variety of business variables specific to the delivery agent, delivery route, shipment type, service type and other specific factors of delivery order and business variables of a more general nature. For example, in some embodiments those factors may include the cost of gas for driving along the delivery order deviation route of the agent, vehicle lease and maintenance costs prorated for the mileage of delivery order deviation route, and delivery agent's average hourly pay prorated for the time required to complete the delivery order. Those factors may also include the costs of using special equipment or services of a party or parties other than delivery agent which are essential for completing shipment delivery. The time required to complete delivery order is determined as the sum of driving time of route deviation plus the required times for shipment loading at the sender location and shipment unloading at the destination address plus the time required for any other actions essential for shipment delivery.

The driving time of route deviation is determined as the difference between delivery agent's predicted driving time across the route that includes the order to be dispatched (A1=>D1=>A2=>A3=>D2=>A4 on FIG. 1) and delivery agent's predicted driving time across the currently dispatched orders' route (A1=>A2=>A3=>A4 on FIG. 1). Similarly, the mileage of route deviation is determined as the difference between delivery agent's predicted mileage across the route that includes the order to be dispatched (A1=>D1=>A2=>A3=>D2=>A4 on FIG. 1) and delivery agent's predicted mileage across the currently dispatched orders' route (A1=>A2=>A3=>A4 on FIG. 1).

In some embodiments, times required for shipment loading and unloading at the sender and recipient address respectively are determined with the evaluation of a number of business variables. Those variables may include the time required for delivery agent to find the parking spot or park at the sender or recipient address, walking or other access time to reach the recipient's or sender's office, loading dock or other shipment storage location and return to the vehicle of the delivery agent, document processing times, shipment loading and unloading times, and other time factors that may contribute to the time that delivery agent will spend at the recipient or sender location.

### Improvement of Predicted Incurred Costs and Delivery Order Timing Determination With Statistical Analysis of the Previous Service Data

In some embodiments business variables contributing to the predicted delivery times and incurred costs of a shipment delivery are improved by statistical analysis of the data about previously completed deliveries. Such statistical analysis may involve storing and analyzing the data about previously completed deliveries, specific recipients' and senders' locations, such as time required for various delivery order components for example delivery agent's vehicle parking time, time of walking to and from the recipient's or sender's office, documents' processing time, shipment loading and unloading time, or other time-consuming actions required for shipment delivery. This statistical analysis may also involve the effect of various business variables of the shipment delivery on the various time and costs factors, for example, service type, shipment type, package type, loading requirements, insurance requirements, etc. Such an analysis may also involve storing and analyzing the data about each delivery agent's past performance, vehicle type, installed equipment, and other business factors specific for each delivery agent. Other statistical analysis may include the influence of independent external factors such as road conditions, season of the year, time of day, etc on the various components of delivery order timing and incurred costs. Predicted incurred costs of the delivery and the times of the delivery are improved by analyzing statistical significance of various contributing business factors and determining the average values of times and costs of relevant constituent components. Those average values are combined to determine the predicted delivery time and incurred costs of a delivery order.

In some embodiments the statistical data about various business variables is collected on the delivery agent's on-board computer system 200 on FIG. 2 and communicated to the Statistical Data Warehouse for further statistical analysis. Such data may include geographical positioning of the delivery agent person or vehicle, times of various stages of the shipment delivery and other data relevant for the determination of time and incurred costs.

### Determination of an Optimal Delay for Making a Dispatching Decision

In some embodiments a delay for making a dispatching decision may be determined by evaluation of a variety of business variables and statistical data about previously completed deliveries. The delay for making a dispatching decision has the purpose of collecting more data about possible other deliveries. This may speculatively increase the effectiveness of the delivery operations and driving down the incurred costs for each individual shipment delivery by dispatching multiple shipment deliveries which have close geographical or route proximity to the same delivery agent, or by minimizing incurred costs by combining other constituent parts of a shipment delivery, such as loading or unloading multiple shipments at the same sender or recipient address, or others.

### Determination of an Optimal Delay for Start of Shipment Delivery or Moving Along the Delivery Route by a Delivery Agent

In some embodiments a delay for start of shipment delivery or moving along the delivery route by the delivery agent may be determined by evaluation of a variety of business variables and statistical data about previously completed deliveries. Delaying the delivery agent's movement has the purpose of collecting more data about possible other deliveries. This may speculatively increase the effectiveness of the delivery operations and driving down the incurred costs for each individual shipment delivery by dispatching multiple shipment deliveries which have close geographical or route proximity to the same delivery agent, or by minimizing incurred costs by combining other constituent parts of a shipment delivery, such as loading or unloading multiple shipments at the same sender or recipient address, or others.

### Configuration of a System and Computer-Program Products for Automated Dispatching of Shipment Delivery Order

FIG. 3 illustrates the possible configuration of a system and computer-program products for automated dispatch of shipment delivery order with the use of methods of claims 1 through 9 described above. In such a system, Customer order-entry and tracking computer system 300 will provide a portal for shipment delivery orders data entry. Such a portal may be an Internet-based application for data entry by human personnel, or a computer system configured to handle logistics, supply-chain or any other operations of the customer requiring co-ordination of movements of goods or documents, or any other computer system that will provide shipment delivery order data over the network to the Dispatch center 110.

In the illustrated embodiment, shipment delivery order data will be stored in the Orders database 111. Dispatch center computer system 110 will process the incoming delivery orders using the methods of Claims 1 through 9 and dispatch them to one of the delivery agents. When the dispatching decision is made by Dispatch center 110 it communicates relevant delivery order data over the network 500 to the Delivery agent's on-board computer system 200.

Dispatch center computer system 110 communicates over the network 500 with the Mapping and routing computer system 400 for determining the predicted times and mileage of various component of delivery routes.

Delivery agent's on-board computer system 200 is a computing device configured to store the delivery order data. It is also configured to communicate delivery agent's geographical positioning and various business variables of the delivery orders to the Dispatch center 110. Those business variables are stored in the Orders database 111 and contribute to the process of automated dispatch by Dispatch center system 110. Concurrently, they are stored in Statistical Data Warehouse 114 for further statistical analysis. This statistical analysis is used for improving determination of the predicted incurred costs and times of the shipment deliveries.

It is contemplated that in various embodiments components of the computer system may be represented by one or several physical computer devices, configured with program code instructions or computer-program products, or any combination thereof. In various embodiments, Network 500 may represent Internet, LAN, in-memory communications or any other data exchange between computer program products, or computer program products and humans.

The invention claimed is:

1. A method for dispatching of a shipment delivery order from a single point of origin to a single point of destination where the entire delivery including obtaining a shipment from the sender, carrying it to the destination, and handing it to the receiver is performed by a single agent, dispatching such order to the delivery agent of a common carrier whose fleet consists of at least two such agents who can deliver the order, the method comprising the steps of:
Step 1. Receiving the information about the delivery order from the customer of a common carrier and storing this information in computer memory
Step 2. Receiving the information on the plurality of other delivery orders dispatched to each delivery agent of a common carrier which are not yet delivered at the time of receiving the order
Step 3. Receiving the information on the current geographical location of each delivery agent of the common carrier
Step 4. Storing in computer memory the information of available delivery routes within delivery area and geographical positions of those routes
Step 5. Determining the future route and times of arrival at various waypoints on the route of each delivery agent by at least one computer processor
Step 6. Selecting and storing in computer memory a subset of delivery agents that have the capability to satisfy order service window and other conditions associated with the order
Step 7. Determining a plurality of costs that would be incurred by the common carrier and/or delivery agent if the delivery order were dispatched to each of the delivery agents by adding the costs incurred by any driving distance, loading and unloading time and expenses and any other additional expenses associated with order delivery
Step 8. Selecting the delivery agent for an order dispatch with minimum costs incurred by delivering the shipment from the subset of those agents selected in Step 5.

2. The method of claim 1 further comprising: storing in computer memory the geographical location of each known address which may be or was before the origin or destination of shipment or a waypoint on the delivery agent route;

3. The method of claim 1 further comprising: obtaining from a device carried by delivery agent and storing in computer memory geographical location of delivery agent while performing deliveries

4. The method of claim 3 further comprising: configuration of a computer system to determine the time necessary for the delivery agent to load and unload a shipment based on origin or destination address, customer of the order, sender of the shipment, receiver of the shipment, shipment physical characteristics, vehicle type, delivery agent performing the delivery and other factors; and usage of such data for determining the costs incurred by order delivery

5. The method of claim 4 further comprising: configuration of a computer system to improve the data obtained in claim 4 with each subsequent order performed by the common carrier to or from the same address, or for the same customer, or by the same delivery agent, or by the same vehicle type by determining statistically corrected values of loading and unloading times for certain addresses, or customers, or delivery agents, or vehicle types, or shipment types

6. The method of claim 1 further comprising: determining an extra route component of delivery order cost for the delivery agent as the sum of extra route required by delivery agent to arrive at the shipment origin address and projected route required by delivery agent to arrive at the shipment destination point

7. The method of claim 6 further comprising: determining the cost and time of the projected route required by delivery agent to arrive at a specific address, the method comprising the steps of:
Step 1. Determining the stretch of route between two waypoints on the current route of delivery agent which are in closest driving proximity to the desired address
Step 2. Adding the costs and driving time of routes from the first node of the stretch A to the desired address and costs and driving time from the desired address to the last node in stretch A and subtracting the costs and driving time of stretch A
Step 3. Adding the costs and loading or unloading or other idle time at the desired address

8. The method of claim 1 further comprising: identifying a delay for making a dispatch decision by determining the latest point in time at which the risk of shipment being delivered outside the service window is acceptable

9. The method of claim 1 further comprising: identifying a delay for delivery agent to start delivery by determining the latest point in time at which the risk of shipment being delivered outside the service window is acceptable.

10. A computer system and computer-program products for automation of dispatching of a shipment delivery order using the methods of claims 1 through 9; said computer system and computer-program products comprising of:
a database configured to store business variables related to shipment orders; and
a database configured to store business data on delivery agents; and
a database configured to store geographical data related to the road network and delivery routes in the service area; and
a data warehouse to store and analyze business variables related to shipment deliveries and improve the efficiency of the dispatching decision by increasing the statistical significance of various delivery order costs and timing factors determinations; and
a computer system carried by the delivery agent, or on-board of a delivery vehicle, configured to communicate delivery agent or vehicle location, and shipment order status, and other business data to the above databases; and
a computer system to process geographical data and determine the shortest routes between various points within a geographical area, mileage of such routes and predicted travel times along such routes for various means of transportation; and
a computer system for creating shipment delivery data or otherwise communicating shipment delivery data from external systems; and
a computer system to make automated dispatching decisions for shipment delivery orders by identifying a delivery agent that will deliver the shipment incurring minimal costs and satisfying the service delivery terms, and to communicate those dispatching decisions data to the said computer system carried by delivery agent.
